(19) United States
(12) Patent Application Publication
(10) Pub. No.: US 2013/0213113 A1
(43) Pub. Date: Aug. 22, 2013

(54) IMPACT TESTING DEVICE

(71) Applicants: Hong Fu Jin Precision Industry (Shenzhen) Co., Lt, (US); HON HAI PRECISION INDUSTRY CO., LTD., (US)

(72) Inventors: TENG-TSUNG HUANG, New Taipei (TW); GUO-JUN YU, Shenzhen (CN); YONG-BING HU, Shenzhen (CN); GONG-SHUI CHENG, Shenzhen (CN); JUN LI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/690,153

(22) Filed: Nov. 30, 2012

(30) Foreign Application Priority Data
Feb. 20, 2012 (CN) 201210037711.7

(51) Int. Cl. G01M 7/08

(52) U.S. Cl. CPC G01M 7/08
USPC 73/12.13

(57) ABSTRACT

An impact testing device used for testing impact resistance of electronic devices is provided. The impact testing device includes a supporting assembly for supporting the electronic device, a falling assembly for an impact head to fall through to hit the testing points of the electronic device on the supporting assembly, and a controller box, electrically connected to the supporting assembly. The controller box controls the supporting assembly to adjust the positions of the electronic device for the impact head to hit different testing points of the electronic device.

### BACKGROUND

1. Technical Field

The present disclosure relates to an impact testing device for testing impact resistances of electronic devices.

2. Description of Related Art

Electronic devices, such as mobile phones, are usually impact tested to test their impact resistance. A typical method to test the electronic device is operating an impact head to make the head fall down to impact a testing point of the electronic device. The impact resistance of the electronic device is determined by the damaged condition of the impact point of the electronic device. While sometimes there may be many points that need to be tested, the position of the electronic device should be able to be changed for the impact test on different testing points. Currently, the position changes of the electronic device are commonly manually operated. However, the manual operation of the position of the electronic device is time consuming and commonly results in imprecise results.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an exemplary embodiment of an impact testing device including a supporting assembly and a falling assembly.

FIG. 2 is an exploded view of the impact testing device shown in FIG. 1.

FIG. 3 is an enlarged and exploded view of the supporting assembly of the impact testing device shown in FIG. 2.

FIG. 4 is another enlarged and exploded view of the supporting assembly of the impact testing device of FIG. 2.

FIG. 5 is an enlarged and exploded view of the falling assembly of the impact testing device shown in FIG. 2.

### DETAILED DESCRIPTION

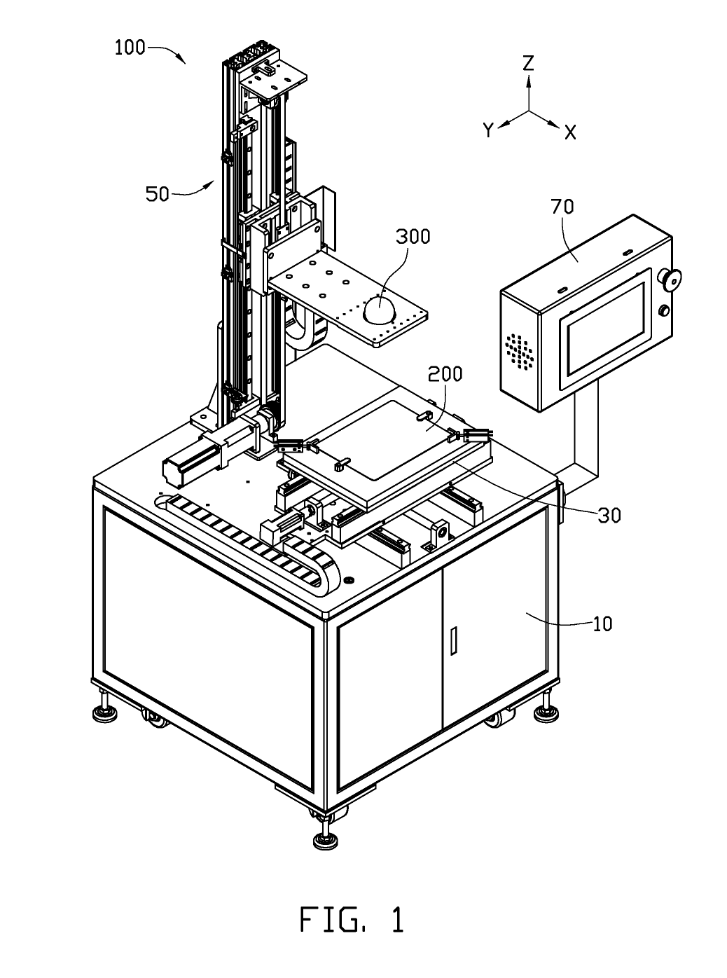

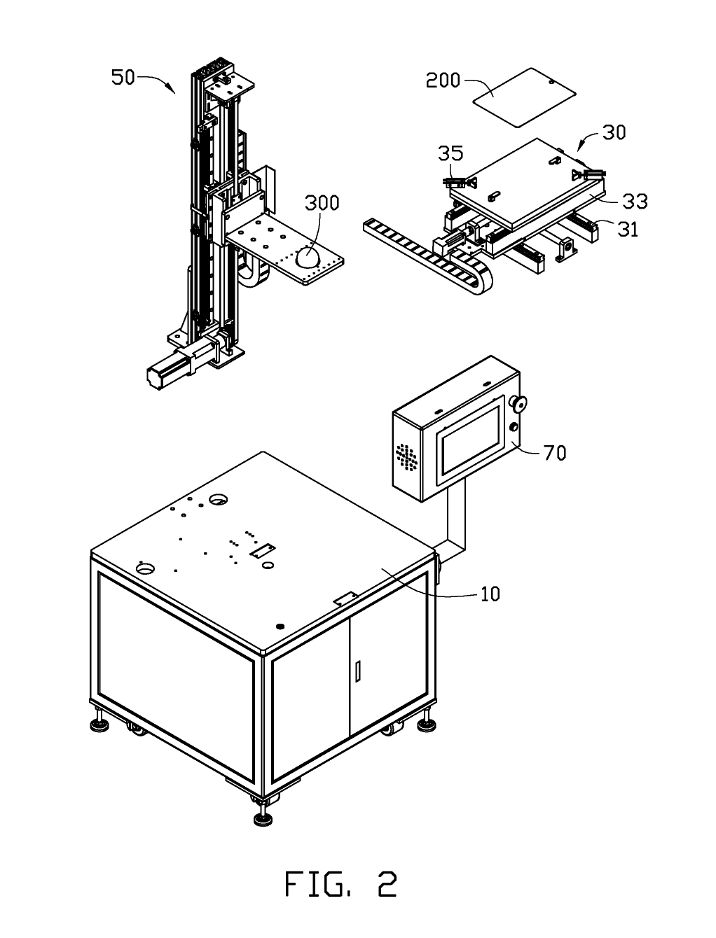

FIGS. 1 and 2 show an impact testing device 100 according to an exemplary embodiment. The impact testing device 100 is used to test the impact resistance of an electronic device 200. The electronic device 200 may be a mobile phone, a PDA, for example.

The impact testing device 100 includes a controller box 10, a supporting assembly 30, a falling assembly 50, and a control station 70. The electronic device 200 is located on the supporting assembly 30.

The controller box 10 electrically connects to the supporting assembly 30, the falling assembly 50, and the control station 70. The control station 70 gives out commands to the controller box 10 to adjust the height of the falling assembly 50 and the position of the supporting assembly 30.

The supporting assembly 30 includes a first adjusting module 31 and a second adjusting module 33 located on the first adjusting module 31. The electronic device 200 is located on the top of the second adjusting module 33. FIG. 1 shows an X-Y-Z coordinate system. The first adjusting module 31 is for removing the electronic device 200 along the X-axis, and the second adjusting module 33 is for removing the electronic device 200 along the Y-axis.

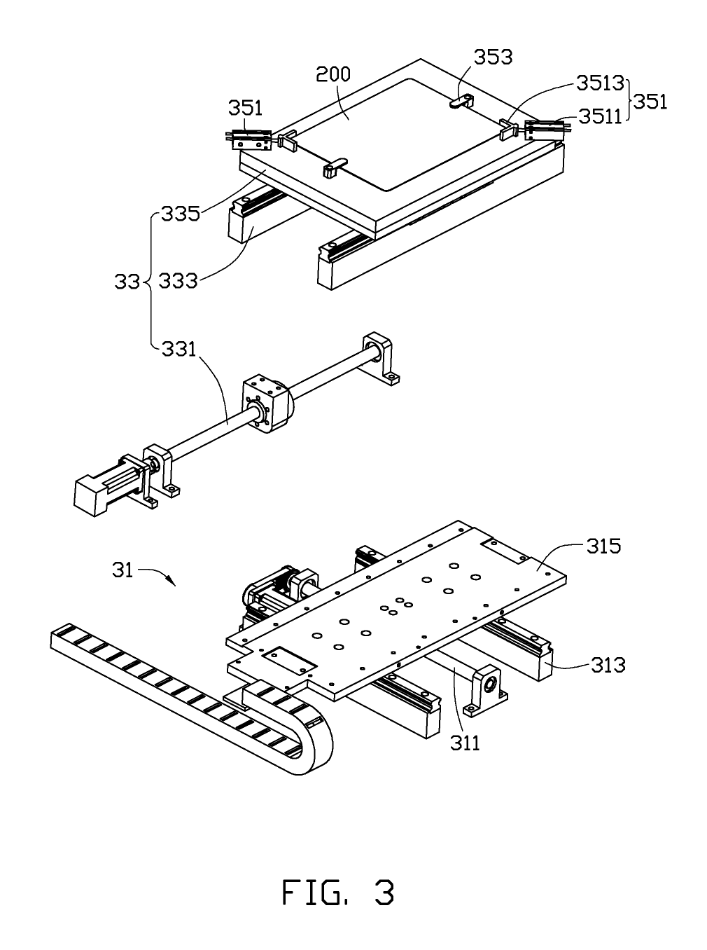

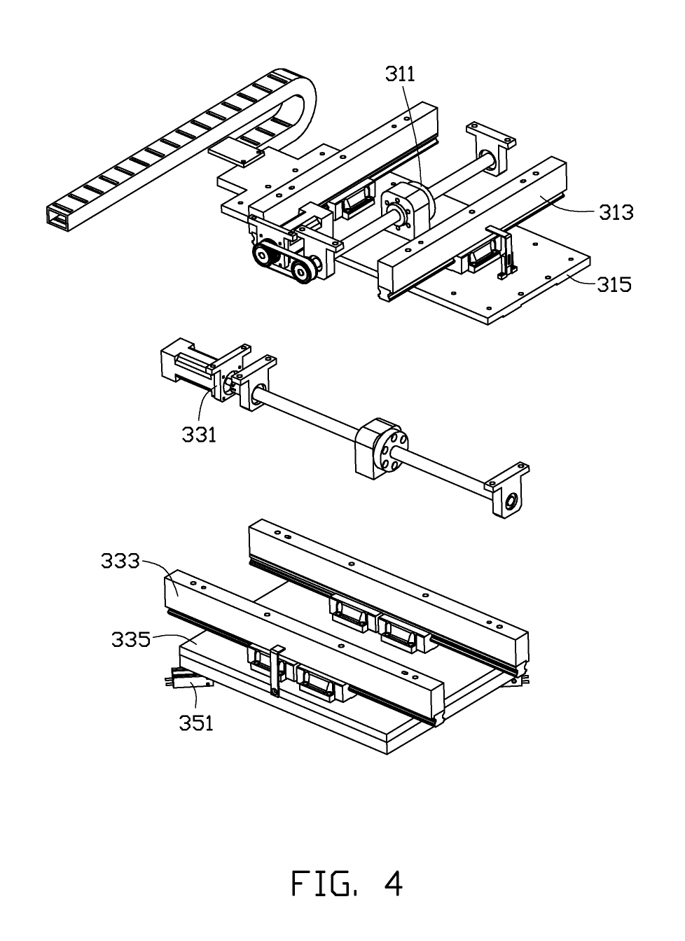

Referring to FIGS. 3 and 4, the first adjusting module 31 includes a first cylinder 311, two first sliding rails 313, and a connecting board 315. The two first sliding rails 313 are arranged in parallel along the X-axis and fastened on the top of the controller box 10. The connecting board 315 is removably mounted on the two first sliding rails 313. The first cylinder 311 is fastened on the controller box 10, and connects the connecting board 315 to drive the connecting board 315 to remove on the first sliding rails 313 along the X-axis.

The second adjusting module 33 is similar to the first adjusting module 31. The second adjusting module 33 includes a second cylinder 331, two second sliding rails 333, and a supporting board 335. The two second sliding rails 333 are arranged in parallel along the Y-axis and fastened on the connecting board 315. The supporting board 335 is removably mounted on the two second sliding rails 333. The second cylinder 331 is fastened on the connecting board 315, and connects the supporting board 335 to drive the supporting board 335 to remove on the second sliding rails 333 along the Y-axis.

In the embodiment, the supporting assembly 30 further includes a limiting module 35 positioned on the supporting board 335 to restrict the electronic device 200 in the testing position (initial position) on the supporting board 335. The electronic device 200 in the embodiment may have a rectangular figure. The limiting module 35 includes two limiting elements 351 and two stopping members 353. The limiting elements 351 are positioned adjacent to one diagonal corners of the electronic device 200. The two stopping members 353 are positioned adjacent to the opposite two sides of the electronic device 200.

Each limiting element 351 includes a limiting cylinder 3511 and a resisting block 3513 connecting to the limiting cylinder 3511. In the embodiment, the resisting blocks 3513 are “L” shaped and towards the electronic device 200. The resisting block 3513 has a shape mating with the corner of the electronic device 200. The two resisting blocks 3513 are driven by the limiting cylinders 3511 to move to the electronic device 200 to catch the diagonal two corners of the electronic device 200 thus limiting the electronic device 200 at an initial location on the supporting board 335. Each stopping member 353 has an end positioning upon the electronic device 200. When a test is started, the limiting cylinders 3511 drive the resisting blocks 3513 away from the electronic device 200 to release the electronic device 200, making the electronic device 200 be tested at a free status. The stopping members 353 and the resisting blocks 3513 prevent the electronic device 200 from falling down from the supporting assembly 30 during test.

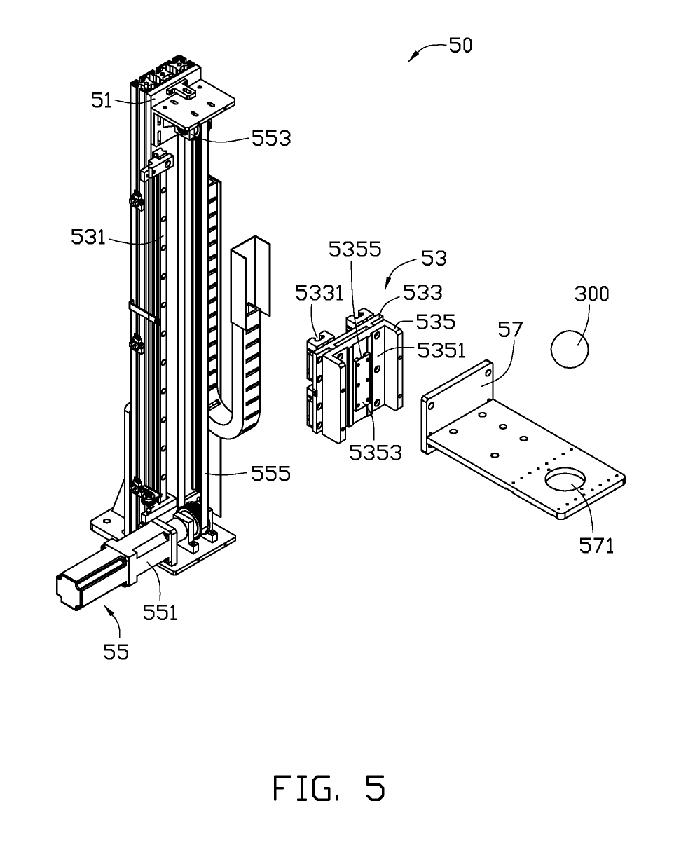

FIG. 5 shows that the falling assembly 50 includes a post 51, a sliding element 53 mounted on the post 51, a driver 55 mounted on the post 51 and connecting to the sliding element 53, and a falling board 57. The post 51 is fastened on the top of the controller box 10 along the Z-axis. The falling board 57 is fastened on the sliding element 53. The driver 55 drives the sliding element 53 and the falling board 57 along the Z-axis to adjust the height of an impact head 300 that falls from the falling board 57 to hit the electronic device 200. The impact head 300 in the embodiment is made of steel or iron and is a sphere having a diameter of about 50 mm and a mass of about 500 g.

The sliding element 53 includes two guiding rails 531, a sliding plate 533 slidably mounted on the two guiding rails 531, and a connecting plate 535 fastened to the sliding plate 533. The two guiding rails 531 are arranged in parallel along the Z-axis and oppositely located on the side of the post 51 towards the supporting assembly 30. The sliding plate 533 defines two sliding grooves 5331 on the side towards the guiding rails 531. The sliding grooves 5331 have shapes mating with the guiding rails 531 for slidably mounting the sliding plate 533 on the guiding rails 531. The connecting plate 535 is fastened on the sliding plate 533 opposite to the sliding grooves 5331. The falling board 57 is fastened to the connecting plate 535. The connecting plate 535 also connects to the driver 55, so that the driver 55 drives the connecting plate 535 to make the sliding plate 533 slide along the guiding rails 531 to adjust the height of the falling board 57 along the Z-axis. In the embodiment, the connecting plate 535 defines a notch 5351, and a connecting block 5353 is formed on the surface of the notch 5351 to form a slot 5355 between the surface of the notch 5351 and the connecting block 5353. The connecting plate 535 connects to the driver 55 by the connecting block 5353 and the slot 5355.

The driver 55 includes a motor 551, a wheel 553, and a driving band 555. The motor 551 and the wheel 533 are located at the two ends of the post 51 along the Z-axis. The driving band 555 surrounds the motor 551 and the wheel 553 and forms two parallel parts along the Z-axis. The part of the driving band 555 far from the post 51 passes through the slot 5355 and locks with the connecting block 5353 of the connecting plate 535, thus connecting the connecting plate 535 to the driving band 555. As such, when the driving band 555 is driven by the motor 551, the driving band 555 drives the connecting plate 535 and the falling board 57 along the Z-axis and adjust the height of the impact head 300. In the embodiment, the motor 551 is fastened on the top of the controller box 10. The wheel 553 is fastened on the top end of the post 51.

The falling board 57 is “L” shaped. The falling board 57 has a part parallel to the supporting assembly 30 in which a falling hole 571 is defined. The falling hole 571 has a diameter a little more than the diameter of the impact head 300 so that the impact head 300 can fall through the falling hole 571 to hit the electronic device 200. The falling board 57 defines another part vertical to the supporting assembly which may be fastened to the connecting plate 535 by screws.

The control station 70 is for testers to input testing parameters, such as the height of the falling board 57 (or the impact head 300), and the testing points of the electronic device 200. The control station 70 also gives out commands to the controller box 10 to control the work of the first cylinder 311, the second cylinder 331, and the motor 551.

When using the impact testing device 100 to test the electronic device 200, the electronic device 200 is first positioned on the supporting board 335, and the limiting elements 351 and the stopping members 353 surround the electronic device 200. Then, testers set the testing parameters on the control station 70. Next, the control station 70 gives out an implementing command to the controller box 10. The controller box 10 controls the limiting elements 351 to put the electronic device 200 at the test location (initial location) on the supporting board 335. Simultaneously, the controller box 10 controls the driver 55 to adjust the height of the falling board 57 along the Z-axis, and drives the first adjusting module 31 and the second adjusting module 33 to remove the electronic device 200 and make the first testing point of the electronic device 200 aim the center of the falling hole 571. At this time, the limiting elements 351 release the electronic device 200 and the impact head 300 falls down through the falling hole 571 of the falling board 57 to hit the first testing point of the electronic device 200. As such, a first test cycle is finished. The impact head 300 can be controlled by an auto-falling device (not shown). After the first test cycle, the limiting elements 351 work to again restrict the electronic device 200 at the initial location on the supporting board 335 (the electronic device 200 may move while being hit by the impact head 300), then the first adjusting module 31 and the second adjusting module 33 change the position of the electronic device 200 to make the second testing point of the electronic device 200 aim the center of the falling hole 571, the limiting elements 351 release the electronic device 200 once more, and then the impact head 300 falls through the falling hole 571 again to hit the second testing point of the electronic device 200. As such, a second test cycle is finished. The other test cycles for the different testing points of the electronic device 200 will be finished similarly.

The impact testing device 100 of the exemplary embodiment can automatically remove the electronic device 200 to make different testing points of the electronic device 200 aim the impact head 300 orderly for tests, which is much more effective. Furthermore, compared to the manual operation of the electronic device 200, the locations of the electronic device 200 controlled by the impact testing device 100 are much more precise, and the test results using the impact testing device 100 are also much more consistent and precise.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An impact testing device used for testing impact resistance of electronic devices, the impact testing device comprising:
a falling assembly for an impact head to fall through to hit the testing points of the electronic device at a desired height;
a supporting assembly for supporting the electronic device; and
a controller box electrically connected to the falling assembly and the supporting assembly, the controller box controlling the falling assembly to adjust the falling height of the impact head, and controlling the supporting assembly to adjust the positions of the electronic device for the impact head to hit different testing points of the electronic device.

2. The impact testing device as claimed in claim 1, wherein the supporting assembly comprises a first adjusting module and a second adjusting module located on the first adjusting module for supporting the electronic device thereon, the first adjusting module drives the second adjusting module and the electronic device to remove along a first direction, the second adjusting module drives the electronic device to remove along a second direction which is vertically to the first direction.

3. The impact testing device as claimed in claim 2, wherein the first adjusting module comprises a first cylinder, two first sliding rails, and a connecting board, the two first sliding rails are arranged in parallel along the first direction and are fastened on the top of the controller box, the connecting board is slidably mounted on the first rails and connected to the first cylinder, the first cylinder drives the connecting board to remove on the first sliding rails along the first direction.

4. The impact testing device as claimed in claim 3, wherein the second adjusting module comprises a second cylinder, two second sliding rails, and a supporting board, the two second sliding rails are arranged in parallel along the second direction and are fastened on the connecting board, the supporting board is slidably mounted on the second sliding rails and connected to the second cylinder, the electronic device is located on the supporting board, the second cylinder drives the supporting board and the electronic device to remove on the second sliding rails along the second direction.

5. The impact testing device as claimed in claim 4, wherein the supporting assembly further comprises a limiting module positioned on the supporting board, the limiting module comprises two limiting elements, the limiting elements locates adjacent to one diagonal corners of the electronic device, each limiting element comprises a limiting cylinder and a resisting block connecting to the limiting cylinder, the two resisting blocks are driven by the limiting cylinders to move to the electronic device to catch the diagonal two corners of the electronic device and limit the electronic device at an initial location on the supporting board, or the two resisting blocks are driven by the limiting cylinders to move away from the electronic device to release the electronic device.

6. The impact testing device as claimed in claim 5, wherein the limiting module further comprises two stopping members located adjacent to the opposite two sides of the electronic device, each stopping member has an end positioning upon the electronic device, the stopping members and the resisting blocks prevent the electronic device from falling down form the supporting assembly during a test.

7. The impact testing device as claimed in claim 1, wherein the falling assembly comprises a post, a sliding element, a driver, and a falling board, the sliding element is slidably mounted on the post and is connected to the driver, the falling board is fastened to the sliding element, the driver is mounted on the post and drives the sliding element and the falling board to remove along the post to adjust the height of the falling board.

8. The impact testing device as claimed in claim 7, wherein the falling board has a part parallel to the supporting assembly and defining a falling hole therein, the falling hole has a diameter larger than the diameter of the impact head, the impact head falls through the falling hole to hit the testing points of the electronic device.

9. The impact testing device as claimed in claim 7, wherein the sliding element comprises tow guiding rails arranged in parallel and oppositely located on the side of the post towards the supporting assembly, and a sliding plate, the sliding plate defines two sliding grooves towards the guiding rails, the sliding grooves mate with the guiding rails to slidably mount the sliding plate on the guiding rails.

10. The impact testing device as claimed in claim 7, wherein the sliding element comprises a connecting plate fastened to the sliding plate opposite to the sliding grooves, the connecting plate defines a notch, a connecting block is formed on the surface of the notch and forms a slot between the surface of the notch and the connecting block, the driver comprises a driving band, the driving band passes through the slot and locks with the connecting block to fasten the connecting plate on the driving band, the driving band drives the sliding plate and the falling board to remove.

11. The impact testing device as claimed in claim 10, wherein the falling board has a part vertically to the supporting assembly being connected to the connecting plate by screws.

12. The impact testing device as claimed in claim 10, wherein the driver further comprises a motor and a wheel located at the two ends of the post, the driving band surrounds the motor and the wheel and forms two parts in parallel, the part of the driving band far from the post passes through the slot and locks with the connecting block to fasten the connecting plate on the driving band, the motor drives the driving band to remove.

13. The impact testing device as claimed in claim 1, wherein the impact testing device further comprises a control station electrically connected to the controller box, the control station for testers to set testing parameters and gives out command to the controller box to adjust the height of the falling assembly and the position of the supporting assembly and the electronic device.

14. The impact testing device as claimed in claim 1, wherein the impact head is made of steel or iron and is a sphere having a diameter of about 50 mm and a mass of about 500 g.

15. An impact testing device used for testing impact resistance of electronic devices, the impact testing device comprising:
a supporting assembly for supporting the electronic device;
a falling assembly for an impact head to fall through to hit the testing points of the electronic device on the supporting assembly; and
a controller box electrically connected to the supporting assembly, the controller box controlling the supporting assembly to adjust the positions of the electronic device for the impact head to hit different testing points of the electronic device.
